(19) United States
(12) Patent Application Publication
(10) Pub. No.: US 2009/0136208 A1
(43) Pub. Date: May 28, 2009

(54) Virtual Video Clipping and Ranking Based on Spatio-Temporal Metadata

(76) Inventors: Flora Gilboa-Solomon, Haifa (IL); Zvi Yehudai, Haifa (IL)

Correspondence Address: IBM CORPORATION, T.J. WATSON RESEARCH CENTER, P.O. BOX 218, YORKTOWN HEIGHTS, NY, 10598, US

(21) Appl. No.: 11/946,067

(22) Filed: Nov. 28, 2007

(51) Int. Cl. H04N 5/91

(52) U.S. Cl. 386/95; 386/E05.003

(57) ABSTRACT

A video data and metadata storage and retrieval system including storage apparatus for storing a plurality of recorded video portions and metadata describing a plurality of geographical locations and corresponding times at which the video portions were recorded, and a computer configured to query the stored metadata, identify a plurality of the recorded video portions that correspond to the metadata resulting from the query, and group any of the identified video portions together into a video clip that are separated by less than a predefined clip gap.

### FIELD OF THE INVENTION

The present invention relates to searching video recordings for desired content.

### BACKGROUND OF THE INVENTION

Video surveillance and analysis are increasingly important aspects of national defense and internal security for many countries around the world. However, as the volume of video data increases, searching for relevant video in huge video data sets has become more complex. Typically, employing standard searching techniques results in a list of complete video files even where only a portion of each video file satisfies the search criteria (e.g., the time and/or the place the video recording was made). Thus, although the end-user may be interested only in a specific portion of a video file, he/she will have to review the entire video file in order to find the relevant scenes.

### SUMMARY OF THE INVENTION

The present invention in embodiments thereof discloses novel systems and method for virtual video clipping and ranking based on spatio-temporal metadata.

In one aspect of the present invention a video data and metadata storage and retrieval system is provided including storage apparatus for storing a plurality of recorded video portions and metadata describing a plurality of geographical locations and corresponding times at which the video portions were recorded, and a computer configured to query the stored metadata, identify a plurality of the recorded video portions that correspond to the metadata resulting from the query, and group any of the identified video portions together into a video clip that are separated by less than a predefined clip gap.

In another aspect of the present invention the clip gap is defined as a length of time separating any of the identified video portions and its next nearest identified video portion.

In another aspect of the present invention the computer is configured to group into the video clip at least two of the identified video portions bounding at least one intermediate video portion not among the identified video portions.

In another aspect of the present invention the computer is configured to group any of the identified video portions together into a plurality of video clips, and rank the video clips according to a relevance measure.

In another aspect of the present invention the relevance measure is expressed as the number of the identified video portions in any of the clips divided by the total number of video portions in the clip, where any of the video clips includes a video portion not among the identified video portions.

In another aspect of the present invention the computer is configured to receive a video data stream of the recorded video portions and a metadata stream of the metadata.

In another aspect of the present invention the metadata includes a description of a first geographical region and a first time stamp associated with a first video recording, and of a second geographical region and a second time stamp associated with a second video recording.

In another aspect of the present invention the video data stream is received from an aerial reconnaissance vehicle performing ground surveillance.

In another aspect of the present invention the metadata stream is provided in synchrony with the video data stream such that as the metadata are received they describe any of the recorded video portions that are received at the same time.

In another aspect of the present invention the descriptions of the geographical regions include geographic coordinates.

In another aspect of the present invention the descriptions of the geographical regions include a single geographic point which represents the center of a predefined shape of a predefined size.

In another aspect of the present invention a method is provided for storing and retrieving video data and metadata, the method including storing a plurality of recorded video portions and metadata describing a plurality of geographical locations and corresponding times at which the video portions were recorded, querying the video and metadata to identify a plurality of the recorded video portions that correspond to the metadata, and grouping any of the identified video portions together into a video clip that are separated by less than a predefined clip gap.

In another aspect of the present invention the grouping step includes grouping where the clip gap is defined as a length of time separating any of the identified video portions and its next nearest identified video portion.

In another aspect of the present invention the grouping step includes grouping into the video clip at least two of the identified video portions bounding at least one intermediate video portion not among the identified video portions.

In another aspect of the present invention the grouping step includes grouping any of the identified video portions together into a plurality of video clips, where any of the video clips includes a video portion not among the identified video portions, and further includes ranking the video clips according to a relevance measure.

In another aspect of the present invention the ranking step includes ranking where the relevance measure is expressed as the number of the identified video portions in any of the clips divided by the total number of video portions in the clip.

In another aspect of the present invention the method further includes receiving a video data stream of the recorded video portions and a metadata stream of the metadata.

In another aspect of the present invention the storing step includes storing as the metadata a description of a first geographical region and a first time stamp associated with a first video recording, and of a second geographical region and a second time stamp associated with a second video recording.

In another aspect of the present invention the receiving step includes receiving the video data stream from an aerial reconnaissance vehicle performing ground surveillance.

In another aspect of the present invention the receiving step includes receiving where the metadata stream is provided in synchrony with the video data stream such that as the metadata are received they describe any of the recorded video portions that are received at the same time.

In another aspect of the present invention the storing step includes storing as the metadata descriptions of the geographical regions that include geographic coordinates.

In another aspect of the present invention the storing step includes storing as the metadata descriptions of the geographical regions that include a single geographic point which represents the center of a predefined shape of a predefined size.

In another aspect of the present invention a computer program is provided embodied on a computer-readable medium, the computer program including a first code segment operative to store a plurality of recorded video portions and metadata describing a plurality of geographical locations and corresponding times at which the video portions were recorded, a second code segment operative to query the video and metadata to identify a plurality of the recorded video portions that correspond to the metadata, and a third code segment operative to group any of the identified video portions together into a video clip that are separated by less than a predefined minimum clip gap.

### BRIEF DESCRIPTION OF THE DRAWINGS

The present invention in embodiments thereof will be understood and appreciated more fully from the following detailed description taken in conjunction with the appended drawings in which:

FIG. 1 is a simplified illustration of a video data and metadata storage system, constructed and operative in accordance with an embodiment of the invention;

FIG. 2 is a simplified conceptual illustration of examples of video data and related metadata, operative in accordance with an embodiment of the invention;

FIG. 3 is a simplified illustration of a video data retrieval system, constructed and operative in accordance with an embodiment of the invention;

FIG. 4 is a simplified conceptual illustration of an exemplary method of defining a query for use with the system of FIG. 3, operative in accordance with an embodiment of the invention;

FIGS. 5A and 5B are simplified conceptual illustrations of exemplary results of a video data retrieval query, operative in accordance with an embodiment of the invention;

FIG. 6 is a simplified flowchart illustration of a method for grouping video portions resulting from a query, operative in accordance with an embodiment of the invention; and

FIG. 7 is a simplified flowchart illustration of a method for ranking grouped video portions, operative in accordance with an embodiment of the invention.

### DETAILED DESCRIPTION OF THE INVENTION

The present invention is now described within the context of one or more embodiments, although the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

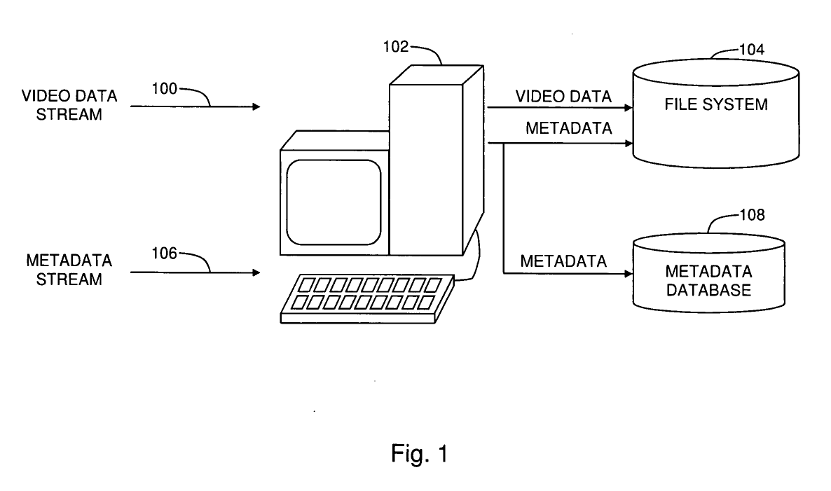

Reference is now made to FIG. 1, which is a simplified illustration of a video data and metadata storage system, constructed and operative in accordance with an embodiment of the invention. In the system of FIG. 1 a video data stream 100 of recorded video, such as from an aerial reconnaissance vehicle performing ground surveillance, is received at a computer 102 and stored in a file system 104. A metadata stream 106 of metadata describing video data stream 100 is also received at computer 102 and preferably includes spatio-temporal data describing the time and geographic location of the recorded video in video data stream 100, such as may be determined at predefined intervals. Metadata stream 106 is preferably provided in synchrony with video data stream 100 such that as metadata are received they describe a recorded video portion that is received at the same time. Metadata from metadata stream 106 are preferably stored as records in a metadata database 108 as well as in file system 104 as a separate metadata file. The metadata in metadata database 108 may represent some or all of the metadata in metadata stream 106, and is preferably made available for querying, such as is described below. The metadata in file system 104 is preferably made available to be streamed along with, and in synchrony with, its corresponding recorded video. While the video is played by a video player, the video's corresponding metadata may also be displayed, such as on a separate metadata viewer showing the metadata overlaid and anchored to a map showing a geographical region of which the video was recorded.

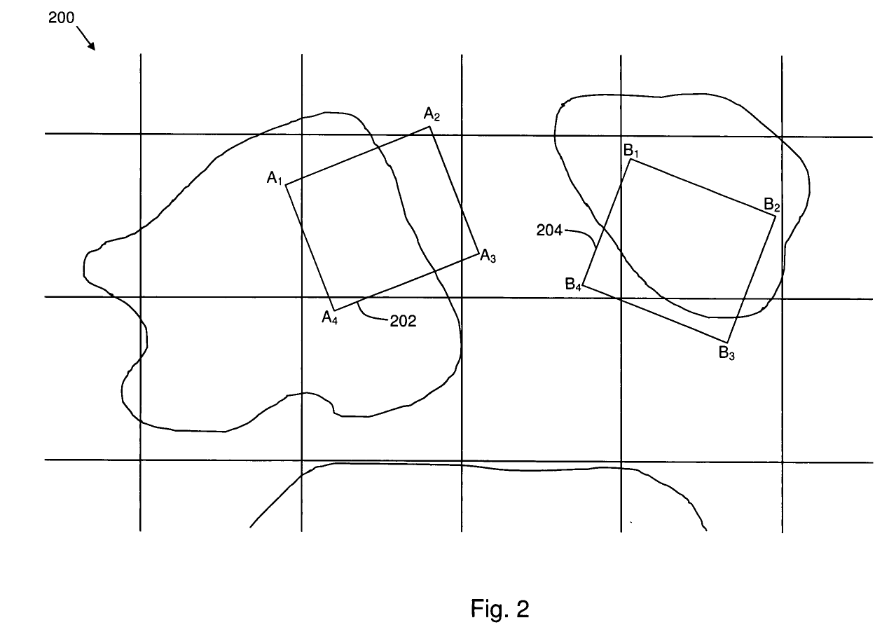

Reference is now made to FIG. 2, which is a simplified conceptual illustration of examples of video data and related metadata, operative in accordance with an embodiment of the invention. In FIG. 2 a grid 200 is shown of a geographical area. A region 202, shown bounded by coordinates (A₁, A₂, A₃, A₄), represents a geographical region of which a video recording was made at time stamp T_{A}, whereas a region 204, shown bounded by coordinates (B₁, B₂, B₃, B₄), represents a geographical region of which a video recording was made at time stamp TB. The system of FIG. 1 may be understood given the examples in FIG. 2 where recorded videos of regions 202 and 204 are received as part of video data stream 100, while their respective coordinates and time indices are received as part of metadata stream 106. Additionally or alternatively to geographic coordinates, a region may be defined by a single geographic point which represents the center of a predefined shape (e.g., a square) of a predefined size (e.g., 1 km×1 km).

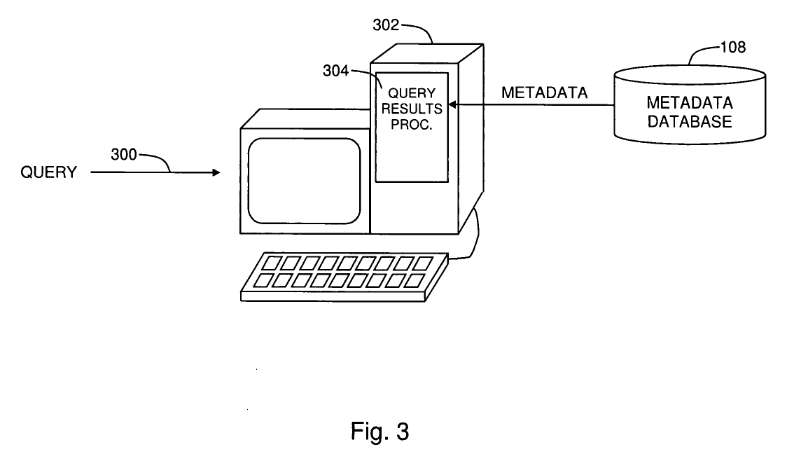

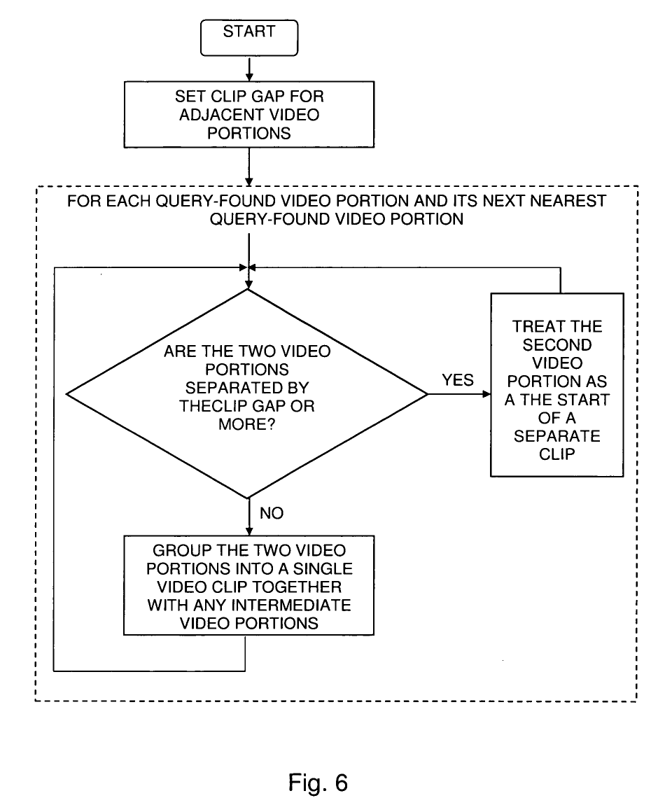

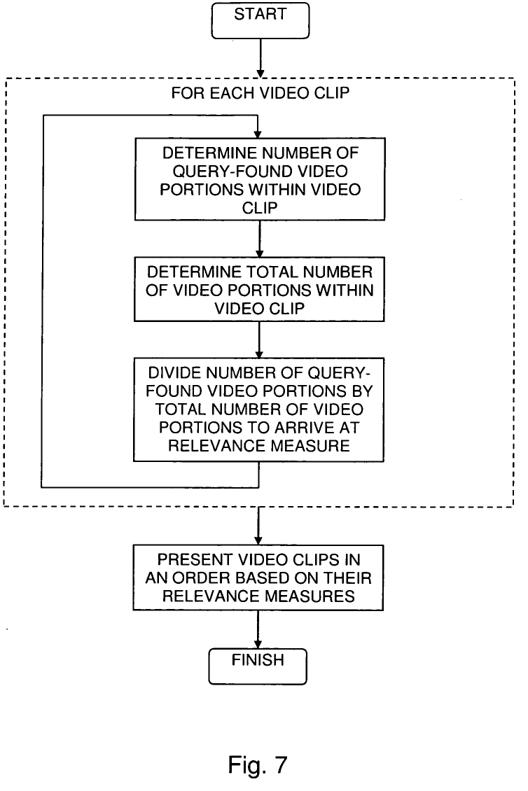

Reference is now made to FIG. 3, which is a simplified illustration of a video data retrieval system, constructed and operative in accordance with an embodiment of the invention. In the system of FIG. 3 a query 300 is preferably composed of two criteria: (1) a geographic location or region, such as a geographical point or a set of geographical coordinates that define a geographic region, and (2) a time stamp. The query is entered into a computer 302 where it is applied to metadata database 108 (FIG. 1) using conventional techniques to identify records that meet the query criteria. Where the query specifies a geographic location, conventional techniques may be employed to identify geographic metadata in metadata database 108 that, while not exactly matching the geographic location or region, nevertheless correspond to recorded video in file system 104 (FIG. 1) that lies within, overlaps to a predefined degree, or lies within a predefined distance from the geographic location or region specified by the query. Computer 302 preferably includes a Query Result Processing Component 304 which processes the retrieved results and creates a list of ranked video clips, such as is described hereinbelow with reference to FIGS. 6 and 7.

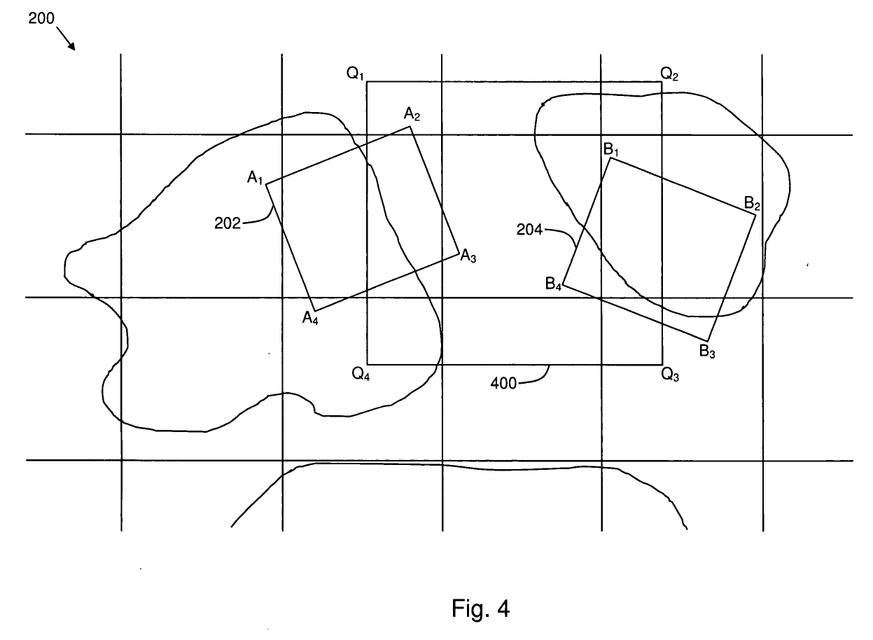

Reference is now made to FIG. 4, which is a simplified conceptual illustration of an exemplary method of defining a query for use with the system of FIG. 3, operative in accordance with an embodiment of the invention. In FIG. 4 grid 200 of FIG. 2 is shown along with regions 202 and 204. A query may be defined by drawing one or more regions of interest 400, shown bounded by coordinates (Q₁, Q₂, Q₃, Q₄), where the goal of the query is to identify any video that has been recorded anywhere within region 400. Additionally or alternatively the query may include a time stamp T_{Q}, or a time range T_{Q1}-T_{Q2}, in order to identify video that has been recorded during the specified times within grid 200. Additionally or alternatively to geographic coordinates, a region may be defined by a single geographic point which represents the center of a predefined shape of a predefined size as described above.

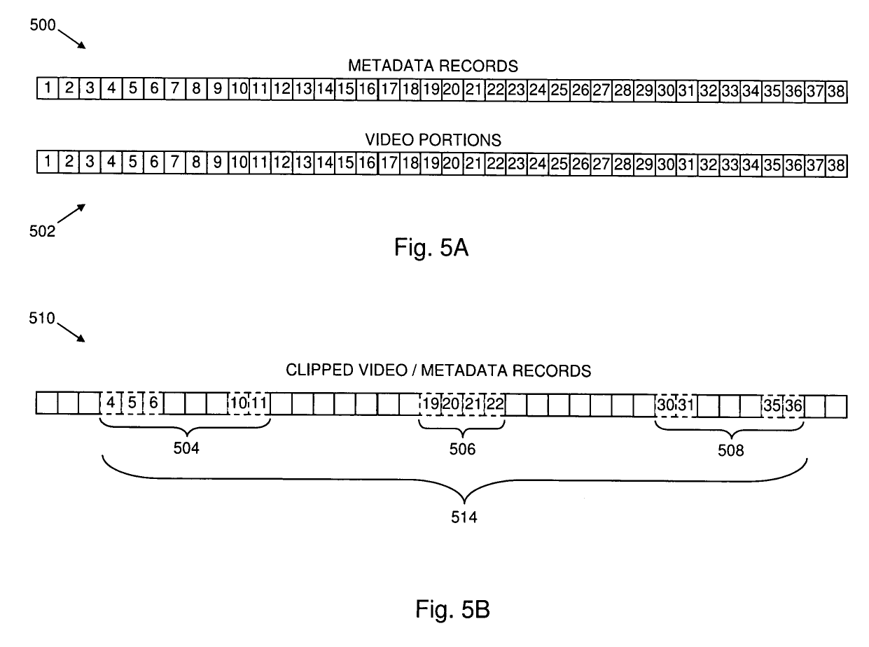

Reference is now made to FIGS. 5A and 5B, which are simplified conceptual illustrations of exemplary results of a metadata retrieval query, operative in accordance with an embodiment of the invention. In FIG. 5A a set 500 of metadata records and a set 502 of portions of recorded video are shown, preferably time-ordered, where each metadata record in set 500 is shown positioned above the video portion in set 502 to which the metadata record corresponds. FIG. 5B shows the results of a query of metadata records that is performed as described hereinabove, where the original video and metadata records that meet the query criteria are marked in dashed lines in a set 510 and may be selected or “clipped” from the rest of set 510, such as for display to a user.

Reference is now made to FIG. 6, which is a simplified flowchart illustration of a method for grouping video portions resulting from a query, operative in accordance with an embodiment of the invention. In the method of FIG. 6 a clip gap of a length of time t, such as 4 seconds, may be defined for each video portion found as the result of a query, such as the type of query described hereinabove, and its next nearest video portion found as the result of the query such that if the two video portions are separated by ≦t they are grouped into a single video clip together with any intermediate video and metadata portions, whereas if the two video portions are separated by >t they are not grouped together. Thus, in the example shown in FIG. 5B, assuming that each video/metadata portion in set 510 is one second in length and t=4 seconds, three video clips 504, 506, and 508 are formed. If t>7, a single clip 514 will be created spanning 504, 506, and 508 and portions in between. The clip gap may be user-defined, and may be defined such that for a given set of video data a longer clip gap time will typically result in fewer, relatively long video clips, while a shorter clip gap time will typically result in more short video clips.

Reference is now made to FIG. 7, which is a simplified flowchart illustration of a method for ranking grouped video portions, operative in accordance with an embodiment of the invention. In the method of FIG. 7, where multiple video clips each include both desired and undesired video portions, such as video portions that satisfy the criteria of a query, as well as video portions that do not, the video clips may be ranked according to a relevance measure, such as the number of desired video portions divided by the total number of video portions in the clip. Thus, for example, when applying the clip gap method of FIG. 6 to the example shown in FIG. 5B, video clips 504, 506, and 508 would have relevance measures of 0.625, 1, and 0.5 respectively. The video clips may then be presented to a user in an order based on relevance measure, such as from greatest to lowest.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

What is claimed is:

1. A video data and metadata storage and retrieval system comprising:
storage apparatus for storing a plurality of recorded video portions and metadata describing a plurality of geographical locations and corresponding times at which said video portions were recorded; and
a computer configured to
query said stored metadata, identify a plurality of said recorded video portions that correspond to said metadata resulting from said query, and
group into a video clip any of said identified video portions together into a video clip that are separated by less than a predefined clip gap.

2. A system according to claim 1 wherein said clip gap is defined as a length of time separating any of said identified video portions and its next nearest identified video portion.

3. A system according to claim 1 wherein said computer is configured to group into said video clip at least two of said identified video portions bounding at least one intermediate video portion not among said identified video portions.

4. A system according to claim 1 wherein said computer is configured to group any of said identified video portions together into a plurality of video clips, and rank said video clips according to a relevance measure.

5. A system according to claim 4 wherein said relevance measure is expressed as the number of said identified video portions in any of said clips divided by the total number of video portions in said clip, wherein any of said video clips includes a video portion not among said identified video portions.

6. A system according to claim 1 wherein said computer is configured to receive a video data stream of said recorded video portions and a metadata stream of said metadata.

7. A system according to claim 1 wherein said metadata includes a description of a first geographical region and a first time stamp associated with a first video recording, and of a second geographical region and a second time stamp associated with a second video recording.

8. A system according to claim 6 wherein said video data stream is received from an aerial reconnaissance vehicle performing ground surveillance.

9. A system according to claim 6 wherein said metadata stream is provided in synchrony with said video data stream such that as said metadata are received they describe any of said recorded video portions that are received at the same time.

10. A system according to claim 7 wherein said descriptions of said geographical regions include geographic coordinates.

11. A system according to claim 7 wherein said descriptions of said geographical regions include a single geographic point which represents the center of a predefined shape of a predefined size.

12. A method for storing and retrieving video data and metadata, the method comprising:
storing a plurality of recorded video portions and metadata describing a plurality of geographical locations and corresponding times at which said video portions were recorded;
querying said video and metadata to identify a plurality of said recorded video portions that correspond to said metadata; and
grouping into a video clip any of said identified video portions together into a video clip that are separated by less than a predefined clip gap.

13. A method according to claim 12 wherein said grouping step comprises grouping where said clip gap is defined as a length of time separating any of said identified video portions and its next nearest identified video portion.

14. A method according to claim 12 wherein said grouping step comprises grouping into said video clip at least two of said identified video portions bounding at least one intermediate video portion not among said identified video portions.

15. A method according to claim 12 wherein said grouping step comprises grouping any of said identified video portions together into a plurality of video clips, and further comprising ranking said video clips according to a relevance measure.

16. A method according to claim 15 wherein said ranking step comprises ranking where said relevance measure is expressed as the number of said identified video portions in any of said clips divided by the total number of video portions in said clip, wherein any of said video clips includes a video portion not among said identified video portions.

17. A method according to claim 12 and further comprising receiving a video data stream of said recorded video portions and a metadata stream of said metadata.

18. A method according to claim 12 wherein said storing step includes storing as said metadata a description of a first geographical region and a first time stamp associated with a first video recording, and of a second geographical region and a second time stamp associated with a second video recording.

19. A method according to claim 17 wherein said receiving step comprises receiving said video data stream from an aerial reconnaissance vehicle performing ground surveillance.

20. A method according to claim 17 wherein said receiving step comprises receiving where said metadata stream is provided in synchrony with said video data stream such that as said metadata are received they describe any of said recorded video portions that are received at the same time.

21. A method according to claim 18 wherein said storing step comprises storing as said metadata descriptions of said geographical regions that include geographic coordinates.

22. A method according to claim 18 wherein said storing step comprises storing as said metadata descriptions of said geographical regions that include a single geographic point which represents the center of a predefined shape of a predefined size.

23. A computer program embodied on a computer-readable medium, the computer program comprising:
a first code segment operative to store a plurality of recorded video portions and metadata describing a plurality of geographical locations and corresponding times at which said video portions were recorded;
a second code segment operative to query said video and metadata to identify a plurality of said recorded video portions that correspond to said metadata; and
a third code segment operative to group into a video clip any of said identified video portions together into a video clip that are separated by less than a predefined minimum clip gap.
